(19) United States
(12) Patent Application Publication
(10) Pub. No.: US 2009/0165933 A1
(43) Pub. Date: Jul. 2, 2009

(54) METHOD FOR PRODUCING A MEMBRANE ELECTRODE UNIT FOR A FUEL CELL

(75) Inventors: Dennis Lösch, Altrip (DE); Sven Thate, Taipei (TW)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/295,150

(22) PCT Filed: Mar. 23, 2007
(86) PCT No.: PCT/EP2007/052836

§ 371 Date: Sep. 29, 2008

(30) Foreign Application Priority Data
Mar. 27, 2006 (EP) 06111768.5

(51) Int. Cl. H01M 8/02; H01M 8/10

(52) U.S. Cl. 156/182

(57) ABSTRACT

A process for producing a membrane-electrode assembly for a fuel cell. The process (a) produces at least one multilayer field on a support, with the at least one multilayer field including at least one electrode layer and at least one membrane layer and the at least one multilayer field being applied to the support such that the at least one multilayer field is surrounded by channels on the support that are bounded on at least one side by edges of the at least one multilayer field, and (b) introduces a flowable, curable sealing material into the channels, which sealing material becomes distributed there to produce a seal surrounding the edges of the at least one multilayer field.

The invention relates to a production process for membrane-electrode assemblies (MEAs), in which seals are produced for reliably sealing the membrane-electrode assemblies.

Fuel cells are energy converters which convert chemical energy into electric energy. In a fuel cell, the principle of electrolysis is reversed. Here, a fuel (for example hydrogen) and an oxidant (for example oxygen) are converted at separate locations at two electrodes into electric current, water and heat. Various types of fuel cells which generally differ from one another in the operating temperature are known now. However, the structure of the cells is in principle the same in all types. They generally comprise two electrodes, viz. an anode and a cathode, at which the reactions occur and an electrolyte between the two electrodes. In the case of a polymer electrolyte membrane fuel cell (PEM fuel cell), a polymer membrane which conducts ions (in particular H⁺ ions) is used as electrolyte. The electrolyte has three functions. It establishes ionic contact, prevents electric contact and additionally keeps the gases fed to the electrodes separate. The electrodes are generally supplied with gases which are reacted in a redox reaction. The electrodes have the task of introducing the gases (for example hydrogen or methanol and oxygen or air), removing reaction products such as water or CO₂, catalytically reacting the starting materials and removing or introducing electrons. The conversion of chemical energy into electric energy takes place at the three-phase boundary of catalytically active sites (for example platinum), ion conductors (for example ion-exchange polymers), electron conductors (for example graphite) and gases (for example H₂ and O₂). A very large active area is critical for the catalysts.

The core of a PEM fuel cell is the membrane-electrode assembly (MEA), viz. a composite of a centrally arranged membrane which is covered on both sides by optionally catalyst-comprising electrodes which are in turn covered with gas diffusion layers (GDLs), i.e. a 5-layer composite. In the fuel cell, the MEA is mounted between two bipolar plates. After installation in a fuel cell, the membrane-electrode assembly is in contact with the fuel gas on the anode side and with the oxidant on the cathode side. The polymer electrolyte membrane separates the regions in which fuel gas and oxidant, respectively, are located from one another. To prevent fuel gas and oxidant coming into direct contact with one another, which could cause explosive reactions, a reliable seal between the gas spaces has to be ensured. It is therefore necessary to have a sealing concept which prevents gas exchange along the edges of the membrane.

Various sealing concepts are known in the prior art, for example from WO 02/093669 A2 or U.S. Pat. No. 5,523,175 A. WO 98/33225 A1 describes, for example, a process by means of which a sealing margin is formed around the periphery of the membrane-electrode assembly, which sealing margin joins the membrane and the electrodes or the electrodes to one another in a gas tight manner and can additionally be joined to a bipolar plate in a gas tight manner. The sealing margin is produced by a sealant, for example a polymer or a mixture of polymers, penetrating into marginal regions of the electrodes at the periphery of the membrane-electrode assembly so that the pores of the electrodes are essentially filled and no longer allow gas to pass through. The polymer, preferably a thermoplastic or a curable, liquid polymer of low viscosity, can penetrate into the electrodes by capillary action and subsequently be cured, or a polymer in liquid form, i.e. molten, uncured or dissolved in a solvent, can be pressed together with the electrodes, if appropriate by application of the necessary pressure (preferably up to about 200 bar) and/or elevated temperature in a suitable apparatus, and the pores of the electrodes filled in this way.

EP 1 018 177 B1 relates to a process for producing a membrane-electrode assembly (MEA) having elastic integral seals, in which the MEA is placed in the interior of a mold which has open channels. A fluidly processable electrically insulating sealing material is then introduced into the mold. The sealing material is conveyed through the channels to the desired seal regions of the MEA. The channels additionally serve as mold surfaces to form one or more raised ribs or thickenings and to impregnate at least part of the electrode layers of the MEA with the sealing material in the seal regions. Furthermore, the channels serve to convey the sealing material so that it extends laterally beyond the membrane-electrode structure and encloses a marginal region of the membrane-electrode structure. The sealing material is cured in order to form the elastic integral seal which additionally comprises the at least one or the plurality of raised ribs or thickenings. The MEA can subsequently be taken from the mold.

A further process for producing a seal for an MEA is provided by WO 2005/008818 A2. Here, the electrode areas are coated in an area where they adjoin at the periphery of the membrane with a surface-active agent which penetrates into them and the edge areas of the MEA are covered by a curable sealant all around their periphery. From the edge areas, the sealant penetrates the regions of the electrodes coated with the surface-active agent. The surface-active agent significantly increases the wettability in the regions treated therewith and as a result aids the application of the sealant and improves its adhesion.

However, the processes known in the prior art frequently have the disadvantage that they are not suitable for simple and efficient mass production. The processes proposed are usually discontinuous with long waiting times and/or are very complicated multistage processes.

It is therefore an object of the present invention to avoid the disadvantages of the prior art and, in particular in the production of a membrane-electrode assembly, ensure reliable sealing combined with simple and efficient manufacture. The continuity of the production of a plurality of membrane-electrode assemblies should be improved.

This object is achieved according to the invention by a process for producing a membrane-electrode assembly for a fuel cell, which comprises the process steps
A) production of at least one multilayer field on a support, with the at least one multilayer field comprising at least one electrode layer and at least one membrane layer and the at least one multilayer field being applied to the support in such a way that the at least one multilayer field is surrounded by channels on the support which are bounded on at least one side by edges of the at least one multilayer field, and
B) introduction of a flowable, curable sealing material into the channels, which sealing material becomes distributed there to produce a seal surrounding the edges of the at least one multilayer field.

The multilayer field comprises at least two superimposed layers and particularly preferably comprises an electrode layer and a membrane layer. However, the multilayer field in the process of the invention can also comprise a major part of the layers or all layers of the membrane-electrode assembly to be sealed, for example an anode layer, a membrane layer and a cathode layer or a first gas diffusion layer, an anode layer, a membrane layer, a cathode layer and a second gas diffusion layer.

In the present invention, the electrode layer comprises one or more electrocatalysts. It preferably comprises a support material such as carbon black or graphite and one or more electrocatalysts. It may, if appropriate, comprise further constituents, for example an ionomer. The membrane layer comprises polymer electrolyte materials. It is usual to use a tetrafluoroethylene-fluorovinyl ether copolymer having acid functions, in particular sulfonic acid groups. Such a material is marketed, for example, under the trade name Nafion® by E.I. DuPont. Examples of membrane materials which can be used for the present invention are the following polymer materials and mixtures thereof:
Nafion® (DuPont; USA)
perfluorinated and/or partially fluorinated polymers such as “Dow Experimental Membrane” (Dow Chemicals, USA),
Aciplex-S® (Asahi Chemicals, Japan),
Raipore R-1010 (Pall Rai Manufacturing Co., USA),
Flemion (Asahi Glass, Japan),
Raymion® (Chlorine Engineering Corp., Japan).

However, it is also possible to use other, in particular essentially fluorine-free, membrane materials, for example sulfonated phenol-formaldehyde resins (linear or crosslinked); sulfonated polystyrene (linear or crosslinked); sulfonated poly-2,6-diphenyl-1,4-phenylene oxides, sulfonated polyaryl ether sulfones, sulfonated polyarylene ether sulfones, sulfonated polyaryl ether ketones, phosphonated poly-2,6-dimethyl-1,4-phenylene oxides, sulfonated polyether ketones, sulfonated polyether ether ketones, aryl ketones or polybenzimidazoles.

In addition, use may be made of polymer materials which comprise the following constituents (or mixtures thereof): polybenzimidazolephosphoric acid, sulfonated polyphenylenes, sulfonated polyphenylene sulfide and polymeric sulfonic acids of the polymer-SO₃X (X═NH₄⁺, NH₃R⁺, NH₂R₂⁺, NHR₃⁺, NR₄⁺) type.

In the process of the invention, a multilayer field is preferably produced by application of a membrane layer field to a support layer and subsequent application of an electrode layer field to the membrane layer field. As support layer, preference is given to using a support film, in particular a film composed of polyester, polyethylene, polyethylene terephthalate (PET), polytetrafluoroethylene (PTFE), polypropylene (PP), polyvinyl chloride (PVC), polycarbonate, polyamide, polyimide, polyurethane or comparable film materials. The support layer preferably has a thickness of from 10 to 250 μm, particularly preferably from 90 to 110 μm.

The application of the membrane layer field to the support is carried out by methods known to those skilled in the art, for example by doctor blade coating, spraying, casting, pressing or extrusion processes. The membrane layer field is subsequently dried. The application of the electrode layer field to the membrane layer field can likewise be carried out by methods known to those skilled in the art. For example, the membrane layer field can be coated with a catalyst-comprising ink. The ink is a solution which comprises an electrocatalyst and is largely liquid or possibly paste-like. It is applied over all or part of the area of the membrane layer field by, for example, printing, spraying, doctor blade coating or rolling. The electrode layer field is subsequently dried.

Suitable drying methods for the individual layers of the multilayer field are, for example, hot air drying, infrared drying, microwave drying, plasma processes or combinations of these methods.

The multilayer field produced by the process of the invention can comprise further layers, for example a gas diffusion layer.

The support according to the present invention is preferably a planar support, the multilayer field being applied to a planar surface.

On the support, the multilayer field is, according to the invention, surrounded along its periphery by channels which are bounded on at least one side by the edges of a multilayer field. In this context, a channel is a prescribed flow path for the sealing material to be introduced which runs along the multilayer field and whose depth corresponds to at least the thickness of the multilayer field. A channel can, for example, be bounded on the one side by the edge (the edge faces) of a first multilayer field and on the other side by the edge (the edge faces) of a second multilayer field, while its underside is formed by the support and it is open at the top. However, a channel can also be bounded only on one side by a multilayer field and otherwise by at least one other delimiting element on the support.

According to the invention, a flowable, curable sealing material is introduced into the channels. The flowable sealing material becomes distributed in the channels (self-organization) and preferably uniformly fills the channels. The sealing material preferably joins onto the edges of the multilayer fields bounding the channels, so that a seal surrounding the edges of the at least one multilayer field is produced. The sealing material can, for example, be poured into the channels or can be introduced into the channels by any other methods known to those skilled in the art. The elastic seal present at the end of the process of the invention surrounds, in particular, the electrode layer and the membrane layer without leaving any gaps and without a precise and therefore complicated positioning of the sealing material being necessary by exploiting the self-organization. The sealing material preferably adheres to the membrane material.

As sealing materials for the process of the invention, preference is given to using polymer materials, in particular polyethylenes, polypropylenes, polyamides, epoxy resins, silicones, Teflon (dispersion), polyvinylidene difluoride (PVDF), polysulfones, polyether ether ketones (PEEK), UV-curable and thermally curable acrylates or polyester resins.

The sealing material is preferably a material which adheres well to the materials of the membrane-electrode assembly, in particular on the material of the membrane layer. For example, a melt adhesive as is disclosed in DE 199 26 027 A1 which comprises ionic or strongly polar groups to produce a surface interaction with the ionic groups of the polymer electrolyte membrane and thus a high adhesive effect can be used as sealing material.

After introduction of the sealing material into the channels, it is solidified, for example by drying, crosslinking (e.g. by means of UV radiation) or cooling.

In a preferred embodiment of the present invention, the at least one multilayer field is produced so that the at least one electrode layer and the at least one membrane layer are flush at the edges or the membrane layer is larger than the electrode layer. Particular preference is given to the membrane layer being larger than the electrode layer. This has the advantage that very precise positioning of the electrode layer field is not necessary when the electrode layer field is applied to the membrane layer field. However, the membrane layer field should project beyond the electrode layer field to which it is joined. This gives, inter alia, the advantage that the membrane layer reliably insulates the electrode layer electrically from a further electrode layer to be arranged on the other side of the membrane layer. Furthermore, the sealing material can bond to the projecting region at the margin of the membrane layer.

It is possible, according to the present invention, for a wetting improver which effects an improvement in the wetting of the of the multilayer field by the sealing material to be applied in the region of the edges before introduction of the sealing material. Such a wetting improver is, for example, a solvent for the sealing material used with which the marginal regions of the multilayer field are wetted. A further possible wetting improver is, for example, a surface-active agent as described in WO 2005/008818 A2, in particular a fluorinated surfactant. The regions treated with the surface-active agent have significantly increased wettability. This aids application of the sealing material and improves its adhesion.

In a preferred embodiment of the process of the invention, the sealing material becomes distributed in the channels and is additionally introduced into pores of a gas diffusion layer in the region of the channels. The gas diffusion layer is gas-permeable and porous and in a PEM fuel cell serves to convey the reaction gases close to the polymer electrolyte membrane.

According to the present invention, the gas diffusion layer can, for example, together with a support film form a support on which at least one multilayer field is arranged, for example a field comprising an electrode layer and a membrane layer. The field is adjoined by channels which run along the field on the gas diffusion layer. However, the gas diffusion layer can also be present as gas diffusion layer field as part of the multilayer field, with the edges of the gas diffusion layer field (in common with the edges of the other layers of the multilayer field) being bounded on one side by channels which are filled with sealing material according to the invention. As a result of the sealing material being allowed to penetrate into the pores of the gas diffusion layer (due to capillary action) so that the gas diffusion layer becomes impregnated with sealing material in this region, a seal which projects beyond the edge of the multilayer field and also encloses the gas diffusion layer and at least substantially penetrates through it in a subregion is produced.

In a preferred embodiment of the present invention, the process of the invention comprises the following steps:
i) production of at least two half membrane-electrode assemblies (half MEAs), in each case by production of a multilayer field comprising a membrane layer and an electrode layer on a support comprising a gas diffusion layer and a support layer and introduction of the sealing material into the channels surrounding the multilayer field, and
ii) joining of two half membrane-electrode assemblies (half MEAs) by joining of the membrane layers of the two half membrane-electrode assemblies (half MEAs) to give a membrane-electrode assembly.

In this process, a membrane-electrode assembly (comprising at least the 5 layers gas diffusion layer, electrode, membrane, electrode, gas diffusion layer) is produced from two half membrane-electrode assemblies (half MEAs) (comprising at least the three layers gas diffusion layer, electrode, membrane). Here, the seals produced by the process of the invention on each of the half MEAs together form a seal of the membrane-electrode assembly.

The joining of the membrane layers of the two half MEAs can be achieved by methods with which those skilled in the art are familiar, for example by hot pressing, lamination, lamination with additional application of solvent or ultrasonic welding. Joining is preferably effected by pressing with application of heat and/or pressure, for example using laminating rollers. The temperature is preferably in the range from 60° C. to 250° C. and the pressure is preferably in the range from 0.1 to 100 bar. When the two half MEAs are joined, a total membrane layer which has the anode layer and a gas diffusion layer on one side and the cathode layer and a gas diffusion layer on the other side is formed from the two membrane layers. When the half MEAs adjoin, the seals of the two half MEAs can also join to form a total seal or they are at least adjacent in a gas tight manner in the resulting membrane-electrode assembly.

In an embodiment of the present invention, a plurality of multilayer fields which
a) each comprise a membrane layer and an electrode layer on a joint support comprising a support layer and a gas diffusion layer or
b) each comprise a membrane layer, an electrode layer and a gas diffusion layer on a joint support comprising a support layer
   and are separated from one another by channels are produced. In case a), the gas diffusion layer is part of the support, while in case b) it is part of the multilayer field. In this embodiment of the process of the invention, neighboring multilayer fields bound the channels laterally and in case a) part of the gas diffusion layer and in case b) part of the support layer forms the bottom of the channels.

In an embodiment of the present invention, at least one additional delimiting element which bounds at least one of the channels on one side is applied to the support. The delimiting elements can, for example, be delimiting strips which run parallel to the edges of the multilayer fields at a distance from them. The delimiting elements can, for example, be produced from the same material and in the same working step as the membrane layer. Their thickness should correspond to at least the thickness of the multilayer field.

The multilayer fields are, in the present invention, preferably four-sided, particularly preferably square or rectangular.

The process of the invention for producing a membrane-electrode assembly has, inter alia, the advantage that it can be carried out as a relatively uncomplicated, inexpensive, continuous roll-to-roll process. For this purpose, for example, the support layer and if appropriate the gas diffusion layer are present as strips on a roll in each case. The half MEAs produced in this way can likewise be wound up on rolls. All working steps of the process of the invention can be combined with continuous roll-to-roll processes. In particular, the distribution of the sealing material by self-organization in the channels between the multilayer fields makes a discontinuous process as is frequently unavoidable in the prior art for plugging on or positioning seals or for introduction and removal from molds superfluous.

In a preferred embodiment, the sealing material is poured into the channels by means of casting apparatuses, with the casting apparatuses either delivering the sealing material continuously or delivering particular periodic amounts of sealing material. This embodiment likewise makes a continuous roll-to-roll process possible. Here, for example, a support strip with multilayer fields and channels surrounding these can move uniformly under the casting apparatuses. Channels in the longitudinal direction of the strip (transport direction) can here be filled with the sealing material by means of a casting apparatus which continuously delivers sealing material in a fixed direction. Channels running perpendicular to the transport direction of the strip can be filled with sealing material by means of narrow casting apparatuses swiveled in the transverse direction or by means of fixed, broad casting apparatuses which deliver sealing material periodically.

In a preferred embodiment of the present invention, a continuous process for producing a plurality of spaced multilayer fields on a support is carried out by applying a plurality of membrane layer fields having a four-sided shape to a strip-like first support layer, applying an electrode layer field to each of the membrane layer fields, joining a strip-like gas diffusion layer as a closed layer to the electrode layer fields, applying a strip-like second support layer to the gas diffusion layer and removing the strip-like first support layer from the multilayer fields. After turning the resulting layer arrangement so that the strip-like second support layer is located on the underside and the membrane layer fields are located on the upper side, the sealing material is, according to the invention, introduced from the top into the channels in which it then becomes distributed (preferably uniformly).

A plurality of membrane-electrode assemblies which are joined to one another via at least the seal is preferably produced in this way and these can be separated by cutting through the seal. If the seal runs between two membrane-electrode assemblies, it can, for example, be cut through the middle so that a half of a seal in each case belongs to a membrane-electrode assembly.

The invention is illustrated below with the aid of the drawing.

In the figures:

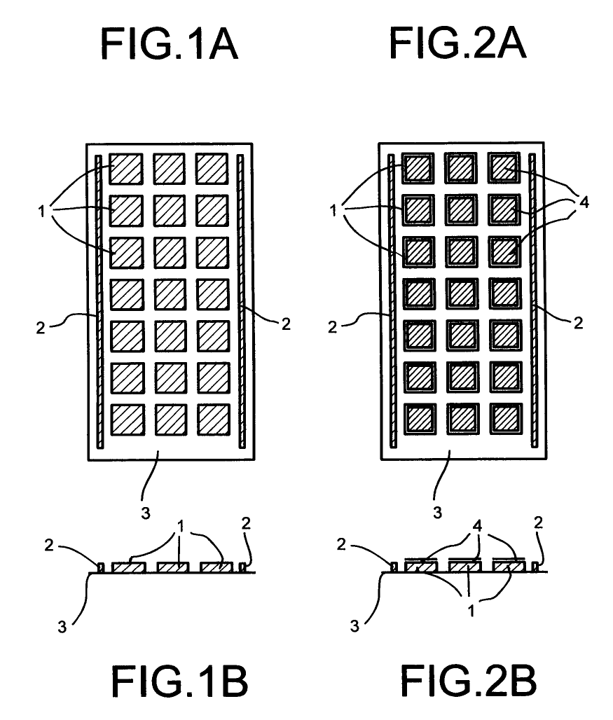

FIGS. 1A and 1B show a first support layer having a plurality of membrane layer fields and delimiting strips in the production of a membrane-electrode assembly by the process of the invention,

FIGS. 2A and 2B show a first support layer with a plurality of multilayer fields comprising a membrane layer and an electrode layer in the production of a membrane-electrode assembly by the process of the invention,

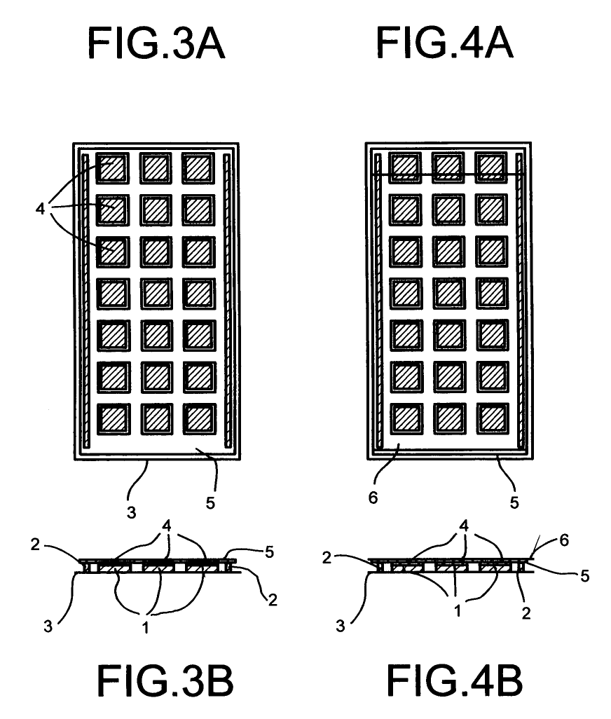

FIGS. 3A and 3B show a gas diffusion layer which is located as a layer on the multilayer fields in the production of a membrane-electrode assembly by the process of the invention,

FIGS. 4A and 4B show a second support layer on the gas diffusion layer in the production of a membrane-electrode assembly by the process of the invention,

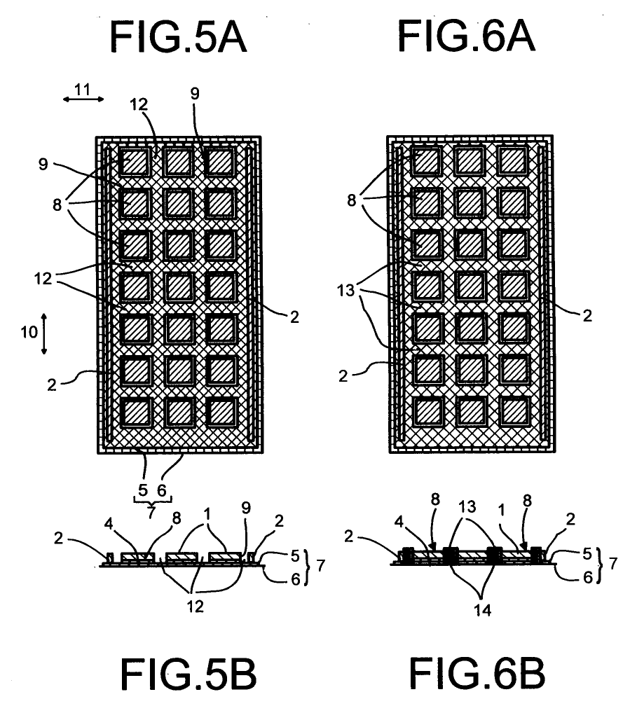

FIGS. 5A and 5B show multilayer fields comprising an electrode layer and a membrane layer on a support comprising a gas diffusion layer and a second support layer in the production of a membrane-electrode assembly by the process of the invention,

FIGS. 6A and 6B show the sealing material distributed in the channels in the production of a membrane-electrode assembly by the process of the invention,

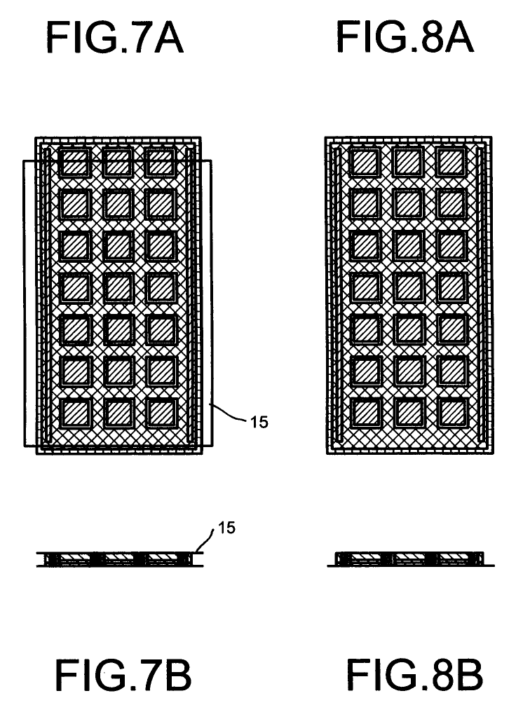

FIGS. 7A and 7B show a third support layer on a plurality of half MEAs joined to one another in the production of a membrane-electrode assembly by the process of the invention,

FIGS. 8A and 8B show the plurality of half MEAs joined to one another without the third support layer in the production of a membrane-electrode assembly by the process of the invention,

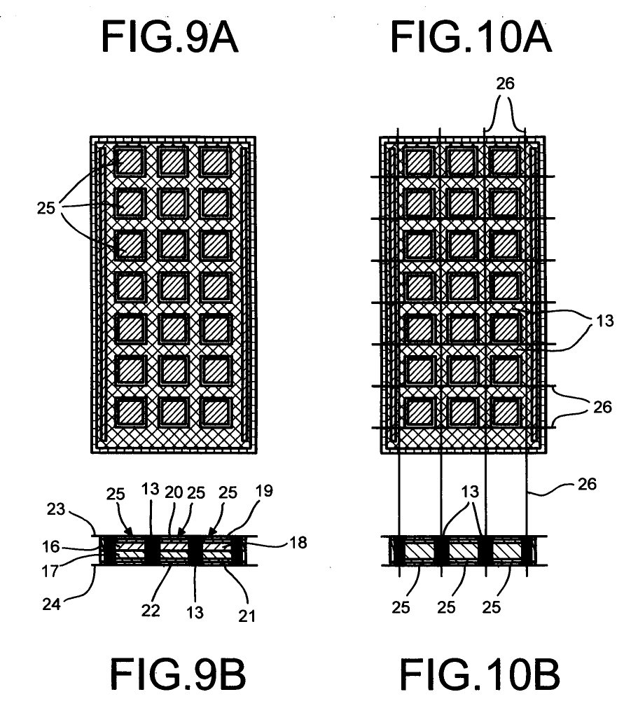

FIGS. 9A and 9B show a plurality of membrane-electrode assemblies joined to one another after the joining of the membrane layers of the half MEAs in production by the process of the invention,

FIGS. 10A and 10B show the cutting lines for separating the membrane-electrode assemblies in production by the process of the invention,

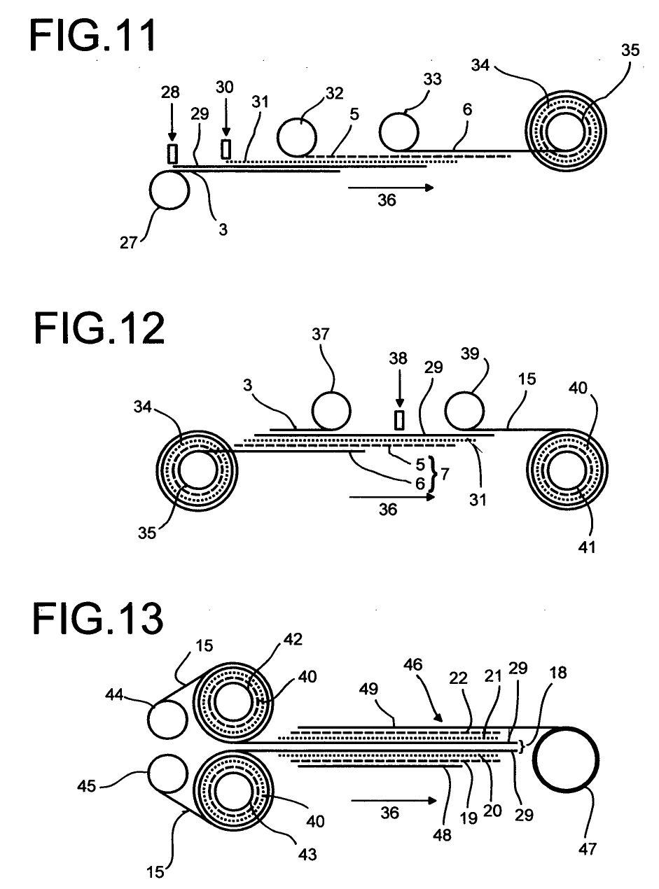

FIG. 11 schematically shows a roll-to-roll process by means of which the intermediate products of the membrane-electrode assemblies produced according to the invention as shown in FIGS. 1A to 4B are produced,

FIG. 12 schematically shows a roll-to-roll process by means of which the half MEAs shown in FIGS. 5A to 7B are produced,

FIG. 13 schematically shows a roll-to-roll process by means of which the membrane-electrode assemblies shown in FIGS. 8A to 9B are produced and

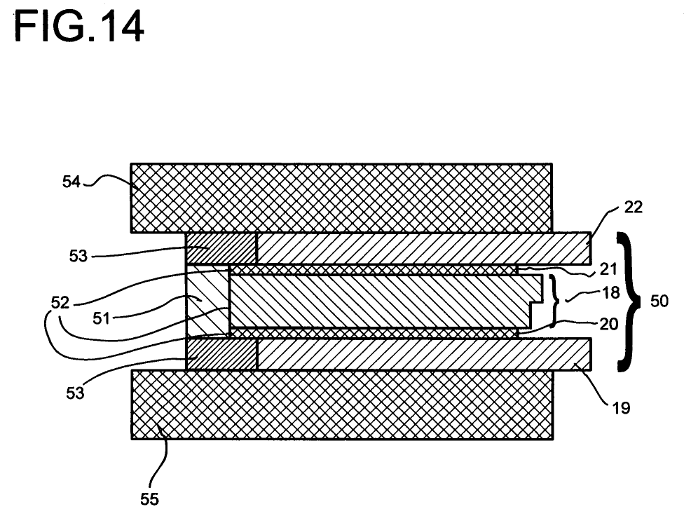

FIG. 14 shows an embodiment of a fuel cell structure comprising a membrane-electrode assembly produced by the process of the invention.

FIG. 1A shows a first intermediate product in the production of membrane-electrode assemblies according to the present invention.

To produce this intermediate product, membrane layer fields 1 and strip-like delimiting elements 2 are applied to a first support layer 3. The membrane layer material (for example an sPEEK casting solution—sulfonated polyether ether ketone) is for this purpose in each case cast, for example, in a rectangular shape as membrane layer field 1 onto the support film (for example of PET).

The casting of the membrane layer fields 1 can be effected by periodic casting and stopping of three parallel, spaced broad casting apparatuses (not shown).

Furthermore, strip-like delimiting elements (for example likewise of sPEEK) which run in the longitudinal direction of the first support layer and are thicker than the membrane layer fields 1 are applied to the first support layer 3. The membrane layer fields 1 and the delimiting elements 2 have to be dried after application to the first support layer 3.

FIG. 1B shows a cross section of the intermediate product of FIG. 1A.

FIG. 2A shows a second intermediate product in the production of membrane-electrode assemblies according to the present invention.

To produce this intermediate product, electrode layer fields 4 are applied to the membrane layer fields 1 located on the first support layer 3, for example by discontinuous doctor blade coating or by screen printing. The electrode layer fields 4 shown in FIG. 2A are rectangular and smaller than the membrane layer fields 1, so that the membrane layer fields 1 project beyond the electrode layer fields 4. The electrode layer fields 4 are dried after application to the membrane layer fields 1.

FIG. 2B shows a cross section of the intermediate product of FIG. 2A.

FIG. 3A shows a third intermediate product in the production of membrane-electrode assemblies according to the present invention.

To produce this intermediate product, a gas diffusion layer 5 is laminated as a full layer onto the electrode layer fields 4. The gas diffusion layer 5 covers all electrode layer fields 4 and the strip-like delimiting elements 2.

FIG. 3B shows a cross section of the intermediate product of FIG. 3A.

FIG. 4A shows a fourth intermediate product in the production of membrane-electrode assemblies according to the present invention.

To produce this intermediate product, a second support layer 6 (for example of PET) is laid loosely onto the gas diffusion layer 5. The second support layer 6 covers the entire gas diffusion layer 5.

FIG. 4B shows a cross section of the intermediate product of FIG. 4A.

FIG. 5A shows a fifth intermediate product in the production of membrane-electrode assemblies according to the present invention.

To produce this intermediate product, the fourth intermediate product shown in FIGS. 4A and 4B is turned over and the first support layer 3 is removed. A support 7 comprising a second support film 6 and a gas diffusion layer 5 then remains, and the delimiting elements 2 and the multilayer fields 8 comprising an electrode layer 4 and a membrane layer 1 are applied to this. The inward-facing edges of the delimiting elements 2 and the edges 9 of the multilayer fields bound a plurality of channels 12 which are located on the gas diffusion layer 5 and extend in the longitudinal direction 10 and in the transverse direction 11. The somewhat larger membrane layer fields 1 are then arranged on top of the somewhat smaller electrode layer fields 4.

FIG. 5B shows a cross section of the intermediate product of FIG. 5A.

FIG. 6A shows a sixth intermediate product (half MEA) in the production of membrane-electrode assemblies according to the present invention.

To produce this intermediate product, a flowable, curable sealing material 13 is, according to the invention, introduced in the channels 12 where it becomes uniformly distributed. The introduction of the fluid sealing material 13 into the channels 12 in the longitudinal direction 10 can, in the case of a support 7 which is moved in the longitudinal direction 10, be achieved by means of individual casting apparatuses or other feed techniques. For the introduction of sealing material 13 into the channels running in the transverse direction 11, it is possible to use, for example, discontinuously (periodically) operating casting apparatuses or feed devices which move back and forth. Precise alignment of the sealing material 13 is not necessary, since self-organization is exploited.

The sealing material 13 flows into the channels and also wets the marginal regions of the undersides of the membrane layer fields 1 which project beyond the electrode layer fields 4. Furthermore, the sealing liquid 13 impregnates the gas diffusion layer 5 in the region of the channels 12 by being introduced into the pores of the gas diffusion layer 5. The impregnated region of the gas diffusion layer 5 is denoted by the reference numeral 14 in FIG. 6B. The sealing material 13 is subsequently solidified (for example by drying, crosslinking or cooling). This gives an elastic seal which, without precise and therefore laborious positioning, surrounds the electrode layer field 4 and the membrane layer field 1 of the respective half MEA without gaps.

FIG. 6B shows a cross section of the intermediate product of FIG. 6A.

FIG. 7A shows the intermediate product of FIG. 6A covered with a third support layer.

If the intermediate product of FIG. 6A is to be rolled up or stacked (for example for temporary storage), it is protected by covering with a third support layer 15 which is removed again for further processing (see FIGS. 8A and 8B—corresponds to the intermediate product of FIGS. 6A and 6B).

FIG. 7B shows a cross section of the intermediate product from FIG. 7A.

FIG. 9A shows a seventh intermediate product in the production of membrane-electrode assemblies according to the present invention.

To produce this intermediate product, two half MEAs are joined to one another by joining their membrane layer fields 16, 17 to form membrane-electrode assemblies. The membrane layer fields 16, 17 in each case join to form a total membrane 18. The intermediate product obtained is a layer which comprises, inter alia, 5-layer membrane-electrode assemblies 25 (first gas diffusion layer 19, first electrode layer 20, membrane 18, second electrode layer 21 and second gas diffusion layer 22) held together via the sealing material 13 and is located between two support layers 23, 24.

FIG. 9B shows a cross section of the intermediate product of FIG. 9A.

To separate the membrane-electrode assemblies 25, cuts running (preferably centrally) through the sealing material 13 can be made along the cutting lines 26 drawn in on FIGS. 10A and 10B. This gives a plurality of individual membrane-electrode assemblies in which the membrane and the electrodes are surrounded completely around the outside edge by the sealing material 13. If the gas diffusion layers have additionally been penetrated by the sealing material 13, all 5 layers of the membrane-electrode assembly are sealed to the edge. When the membrane-electrode assembly is installed between two bipolar plates, both gas spaces of the fuel cell are consequently separated from one another in a gas tight manner.

FIG. 11 schematically shows a continuous roll-to-roll process by means of which the intermediate products of FIGS. 1A to 4B can be produced.

In this roll-to-roll process, which proceeds in the transport direction 36, a first roll 27 supplies a first support layer 3 as rolled material. A first casting apparatus 28 casts membrane layer fields of membrane material 29 (for example sPEEK) onto the first support layer 3 which is moved in the transport direction 36 in order to obtain the intermediate product of FIGS. 1A and 1B. A second casting apparatus 30 casts electrode layer fields of electrode material 31 onto the membrane layer fields which have moved further in the transport direction 36 in order to obtain the intermediate product of FIGS. 2A and 2B. From a second roll 32, a gas diffusion layer 5 is unrolled as rolled material and laminated onto the electrode layer fields which have moved further in the transport direction 36 in order to obtain the intermediate product of FIGS. 3A and 3B. From a third roll 33, a second support layer 6 is unrolled as rolled material and laid onto the gas diffusion layer 5 which has moved further in the transport direction 36 in order to obtain the intermediate product of FIGS. 4A and 4B. The strip-like first MEA intermediate product 34 obtained in this way can, as shown in FIG. 11, be rolled up on a fourth roll 35 or be directly processed further.

FIG. 12 schematically shows a continuous roll-to-roll process by means of which the intermediate products of FIGS. 5A to 7B can be produced.

In this roll-to-roll process, the first MEA intermediate product 34 obtained in a process as shown in FIG. 11 is unrolled from the fourth roll 35, which has been turned around, in the transport direction 36 so that the first support layer 3 is now located on the upper side. The first support layer 3 is removed from the first MEA intermediate product 34 by being rolled up on a fifth roll 37 in order to obtain the intermediate product of FIGS. 5A and 5B. Sealing material 13 is introduced by means of a third casting apparatus 38 into the channels between the multilayer fields of electrode material 31 and membrane material 29 which are located on the strip-like support 7 which comprises a second support layer 6 and a gas diffusion layer 5 and is moved in the transport direction 36. In this way, the intermediate product (strip-like cohesive half MEAs 40) as shown in FIGS. 6A and 6B is obtained as a result. A third support layer 15 is unrolled as rolled material from a sixth roll 39 and laid onto the half MEAs 40 which have moved further in the transport direction 36 in order to obtain the intermediate product of FIGS. 7A and 7B. The strip-like cohesive half MEAs 40 obtained in this way are, as shown in FIG. 12, rolled up on a seventh roll 41 or are directly processed further.

FIG. 13 schematically shows a continuous roll-to-roll process by means of which the membrane-electrode assemblies of FIGS. 8A to 9B are produced.

The third support layer 15 is in each case taken off from two opposite rolls 42, 43 comprising half MEAs 40 like the seventh roll 41 in FIG. 12 and is rolled up on two further rolls 44, 45. The remaining half MEAs 40 as shown in FIGS. 8A and 8B are unrolled from the two opposite rolls 42, 43 in the transport direction 36 so that the membrane layer fields of membrane material 29 of the two half MEAs face one another. The two half MEAs 40 are then joined to one another in order to obtain strip-like joined membrane-electrode assemblies 46 as shown in FIGS. 9A and 9B. The membrane-electrode assemblies 46 have the layer sequence first gas diffusion layer 19, first electrode layer 20, total membrane 18, second electrode layer 21 and second gas diffusion layer 22. The strip-like joined membrane-electrode assemblies 46 can be rolled up with support layers 48, 49 on a storage roll 47 or be separated by means of a cutting apparatus (not shown).

FIG. 14 shows a schematic cross section of an embodiment of a fuel cell structure comprising a membrane-electrode assembly produced by the process of the invention.

The membrane-electrode assembly 50 comprises five layers, viz. a first gas diffusion layer 19, a first electrode layer 20, a membrane 18, a second electrode layer 21 and a second gas diffusion layer 22. The membrane 18 is larger than the electrode layers 20, 21 and projects beyond these. The membrane-electrode assembly 50 further comprises a seal 51 which surrounds the periphery of the membrane-electrode assembly. The seal 51 was produced by introducing a flowable sealing material into channels which were bounded on one side by the edges 52 of the electrode layers 20, 21 and the membrane layers comprised in the membrane 18 and in which the sealing material became distributed by self-organization. The seal therefore adjoins the edges 52 without leaving gaps. Furthermore, the sealing material was introduced into the pores of the gas diffusion layers 19, 22, so that the regions 53 impregnated with sealing material were formed. As a result, the seal 51 extends over the total thickness of the membrane-electrode assembly 50. The membrane-electrode assembly 50 is arranged between two bipolar plates 54, 55 in order to complete the fuel cell structure. In a fuel cell stack (not shown), a plurality of cells are stacked on top of one another in an electrical sequence, with the cells being separated from one another by an impermeable, electrically conductive, bipolar plate, designated as bipolar plate 54, 55. The bipolar plate 54, 55 connects to cells mechanically and electrically. Since the voltage of an individual cell is in the region of 1V, it is necessary for practical applications to connect a large number of cells in series. Up to 400 cells separated by bipolar plates 54, 55 are frequently stacked on top of one another. The cells are stacked on top of one another so that the oxygen side of one cell is connected to the hydrogen side of the next cell via the bipolar plate 54, 55. The bipolar plate 54, 55 thus performs a number of functions. It serves to connect the cells electrically, to supply and distribute reactants (reaction gases) and coolants and to separate the gas spaces. The two gas spaces of a fuel cell are separated from one another in a gas tight manner by the seal 51 of the membrane-electrode assembly 50 installed between the two bipolar plates 54, 55.

### LIST OF REFERENCE NUMERALS

1 membrane layer fields
2 delimiting elements
3 first support layer
4 electrode layer fields
5 gas diffusion layer
6 second support layer
7 support
8 multilayer fields
9 edges
10 longitudinal direction
11 transverse direction
12 channels
13 sealing material
14 impregnated region
15 third support layer
16 first membrane layer field
17 second membrane layer field
18 total membrane
19 first gas diffusion layer
20 first electrode layer
21 second electrode layer
22 second gas diffusion layer
23 upper support layer
24 lower support layer
25 membrane-electrode assemblies
26 cutting lines
27 first roll
28 first casting apparatus
29 membrane material
30 second casting apparatus
31 electrode material
32 second roll
33 third roll
35 fourth roll
36 transport direction
37 fifth roll
38 third casting apparatus
39 sixth roll
40 half MEAs
41 seventh roll
42 eighth roll
43 ninth roll
44 tenth roll
45 eleventh roll
46 membrane-electrode assemblies
47 storage roll
48 support layer
49 support layer
50 membrane-electrode assembly
51 seal
52 edges
53 impregnated regions
54 first bipolar plate
55 second bipolar plate

1-8. (canceled)

9: A process for producing a membrane-electrode assembly for a fuel cell, comprising:
(a) producing at least one multilayer field on a support, with the at least one multilayer field including at least one electrode layer and at least one membrane layer and the at least one multilayer field being applied to the support such that the at least one multilayer field is surrounded by channels on the support that are bounded on at least one side by edges of the at least one multilayer field;
(b) introducing a flowable, curable sealing material into the channels, which sealing material becomes distributed to produce a seal surrounding the edges of the at least one multilayer field;
(c) producing at least two half membrane-electrode assemblies in each case by production of a multilayer field comprising a membrane layer and an electrode layer on a support comprising a gas diffusion layer and a support layer and introducing the sealing material into the channels surrounding the multilayer field; and
(d) joining two half-membrane electrode assemblies by the membrane layers of the two half membrane-electrode assemblies to give a membrane-electrode assembly,
wherein a plurality of multilayer fields which
(i) each comprise a membrane layer and an electrode layer on a joint support including a support layer and a gas diffusion layer or
(ii) each comprise a membrane layer, an electrode layer and a gas diffusion layer on a joint support including a support layer and are separated from one another by channels,
are produced

10: The process according to claim 9, wherein the at least one multilayer field is produced so that the at least one electrode layer and the at least one membrane layer are flush at the edges or the membrane layer is larger than the electrode layer.

11. The process according to claim 9, wherein a wetting improver that effects an improvement in wetting of the edges of the multilayer field by the sealing material is applied in the region of the edges before introduction of the sealing material.

12: The process according to claim 9, wherein the sealing material that becomes distributed in the channels is additionally introduced into pores of a gas diffusion layer in the region of the channels.

13: The process according to claim 9, wherein at least one additional delimiting element that bounds at least one of the channels of one side is applied to the support.

14: The process according to claim 9, wherein the sealing material is poured into the channels by casting apparatuses, with the casting apparatuses either delivering the sealing material continuously or delivering particular periodic amounts of sealing material.

15: The process according to claim 9, wherein, in a continuous process for producing a plurality of spaced multilayer fields on a support, a plurality of membrane layer fields having a four-sided shape are applied to a strip-like first support layer, an electrode layer field is applied to each of the membrane layer fields, a strip-like gas diffusion layer is joined as a closed layer to the electrode layer fields, a strip-like second support layer is applied to the gas diffusion layer, and the strip-like first support layer is removed from the multilayer fields.

16: The process according to claim 9, wherein a plurality of membrane-electrode assemblies that are joined to one another in a strip-like fashion via at least the seal is produced and are separated by cutting through the seal.
